(19) United States
(12) Patent Application Publication
(10) Pub. No.: US 2022/0176717 A1
(43) Pub. Date: Jun. 9, 2022

(54) MEDIA FEED APPLIANCES

(71) Applicant: Hewlett-Packard Development Company, L.P., Spring, TX (US)

(72) Inventors: Douglas KNIGHT, San Diego, CA (US); Stephen LEDAK, San Diego, CA (US); Warren H. PEETZ, III, San Diego, CA (US)

(73) Assignee: Hewlett-Packard Development Company, L.P., Spring, TX (US)

(21) Appl. No.: 17/437,105

(22) PCT Filed: Jan. 17, 2020
(86) PCT No.: PCT/US2020/014070

§ 371 Date: Sep. 8, 2021

(51) Int. Cl. B41J 11/42; B41J 29/393; B41J 15/16; B41J 3/36

(52) U.S. Cl. CPC B41J 11/425; B41J 3/36; B41J 15/16; B41J 29/393

(57) ABSTRACT

A media feed appliance can include a media pull guide to guide a print medium through a path while the print medium is manually pulled through the media feed appliance. The media feed appliance can also include a drive gear that is manually driven using frictional contact with the print medium while the print medium is pulled over a surface of the drive gear. The media feed appliance can also include a printer positioning port to position a manually actuatable printer to print on the print medium, wherein the drive gear of the media feed appliance is positioned to mechanically engage with a printer gear when the manually actuatable printer is docked at the port.

### BACKGROUND

Printing on a media, such as ribbon media, typically employs commercial equipment such as large printers with specialized feed equipment. The cost of the specialized feed equipment and commercially available printers can make it difficult for average users to print using this or other types of similar media in small quantity. The size of the commercially available printers and specialized feed equipment can also provide some barrier to use in home, office, and/or mobile settings.

### BRIEF DESCRIPTION OF DRAWINGS

FIG. 1A schematically depicts an example media feed appliance with a print medium in accordance with the present disclosure;

FIG. 1B schematically depicts an example media pull guide for use with a media feed appliance in accordance with the present disclosure;

FIG. 1C schematically depicts an example tensioner for use with a media feed appliance in accordance with the present disclosure;

FIG. 1D depicts a cross-sectional view of an example friction enhancing media path for use with a media feed appliance in accordance with the present disclosure;

FIG. 1E schematically depicts an example drive system for use with a media feed appliance in accordance with the present disclosure;

FIG. 1F schematically depicts an example housing for use with a media feed appliance in accordance with the present disclosure;

FIG. 1G schematically depicts example clips for use with a media feed appliance in accordance with the present disclosure;

FIG. 1H schematically depicts an example media printing system in accordance with the present disclosure; and

FIG. 2 depicts an example method of printing on a media in accordance with the present disclosure.

### DETAILED DESCRIPTION

The present disclosure is drawn to a media feed appliance, a printing system, and a method for printing on a print medium. In one example, a media feed appliance includes a media pull guide to guide a print medium through a path while the print medium is manually pulled through the media feed appliance, a drive gear that is manually driven using frictional contact with the print medium while the print medium is pulled over a surface of the drive gear, and a printer positioning port to position a manually actuatable printer to print on the print medium. The drive gear of the media feed appliance in this example is positioned to mechanically engage with a printer gear when the manually actuatable printer is docked at the port. In one example, a media holder can be included to hold and dispense the print medium during printing. The media feed appliance can, for example, be adjustable for different print medium widths. In one example, the media feed appliance can include a tensioner to provide a friction enhancing media path to generate back tension on the print medium while moving through the media feed appliance. A portion of the tensioner can be detachable while the print medium is being loaded into the media feed appliance. The friction enhancing media path can be created by the tensioner and can be serpentine or non-linear, for example. The media feed appliance, for example, can be manufactured using three dimensional printing. In one example, the drive gear can be non-motorized. The drive gear can be included as part of a plurality of gears that are positioned so that the drive gear that contacts the print medium and a gear that engages the printer gear are operationally coupled together. The print medium can be included as a rolled print medium, a ribbon print medium, a paper print medium, a tape print medium, or a plastic print medium, for example. The path for the print medium can have a width to accommodate a print medium that is one-fourth of an inch to four inches in width.

In another example, a media printing system includes a manually actuatable printer with a printer gear to drive printing on a print medium and a media feed appliance. The media feed appliance in this example includes a media pull guide to guide a print medium through a path while the print medium is manually pulled through the media feed appliance, a drive gear that is manually driven using frictional contact with the print medium while the print medium is pulled over a surface of the drive gear, and a printer positioning port to position the manually actuatable printer to print on the print medium. For example, the drive gear of the media feed appliance can be positioned to mechanically engage with a printer gear when the manually actuatable printer is docked at the port. The manually actuatable printer can be a handheld mobile printing device that employs an inkjet printing system, for example. The media printing system can also include a tensioner to provide a friction enhancing media path to generate back tension on the print medium while moving through the media feed appliance.

In another example, a method of printing on a print medium includes manually pulling a print medium through a path in a media feed appliance, driving a drive gear of the media feed appliance using frictional contact from the print medium being manually pulled over a surface of the drive gear, and driving a printer gear of a manually actuatable printer via the drive gear of the media feed appliance. In further detail, the method further includes printing on the print medium while the printer gear is being driven and the print medium is being manually pulled through the path of the media feed appliance. In one example, the method can also include loading a roll of the print medium onto a media holder of the media feed appliance to dispense the print medium during printing, and creating back tension on the print medium in the media feed appliance via a tensioner.

It is noted that when discussing the media feed appliances, the media printing systems, and/or the methods of printing, these discussions can be considered applicable to other examples whether or not they are explicitly discussed in the context of that example. Thus, for example, in discussing a tensioner in reference to a media feed appliance, such disclosure is also relevant to and directly supported in context of the media printing system or the method of printing, and vice versa.

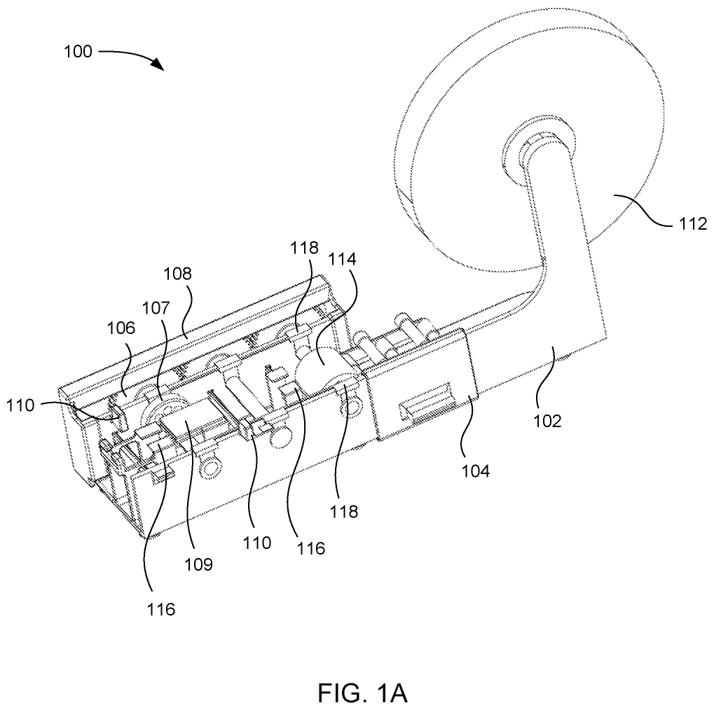

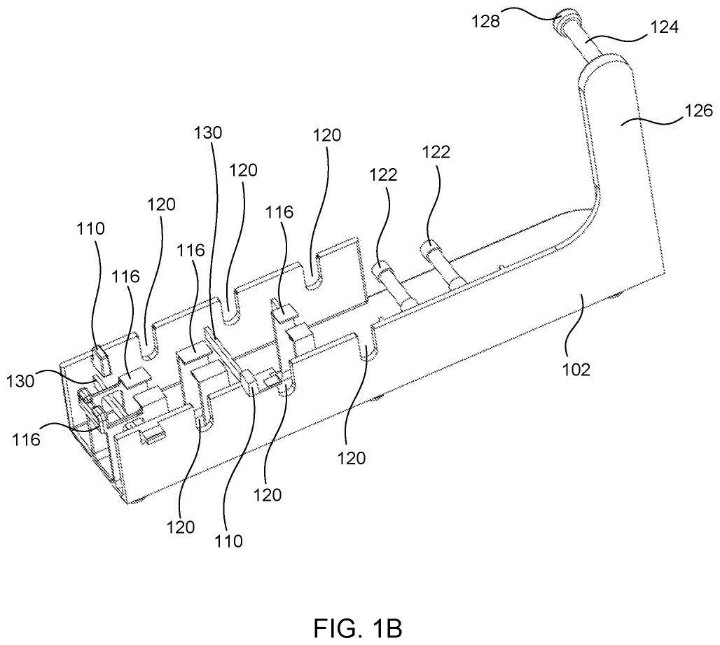

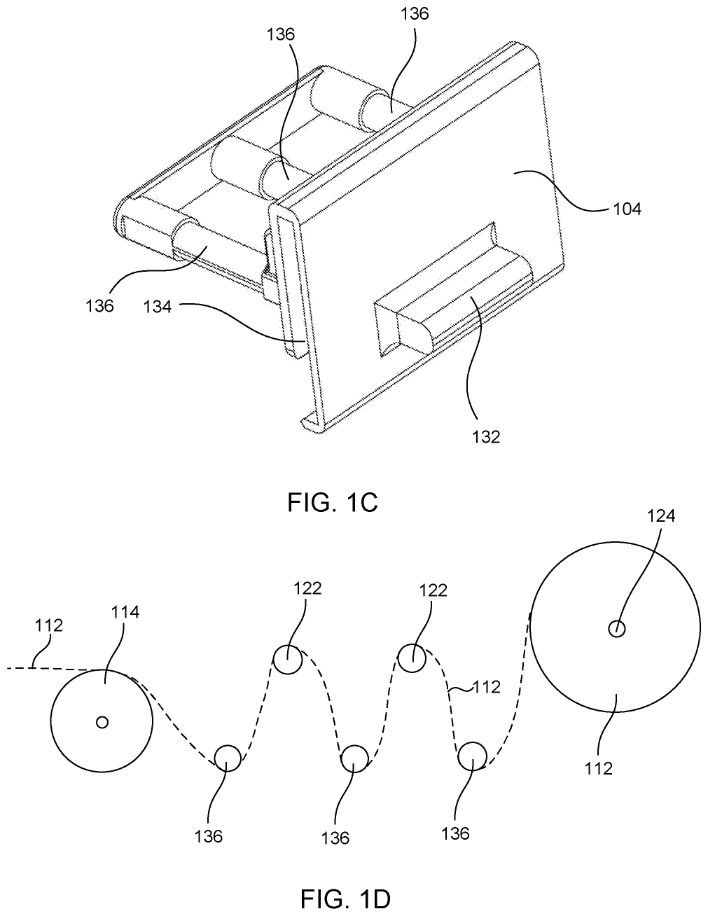

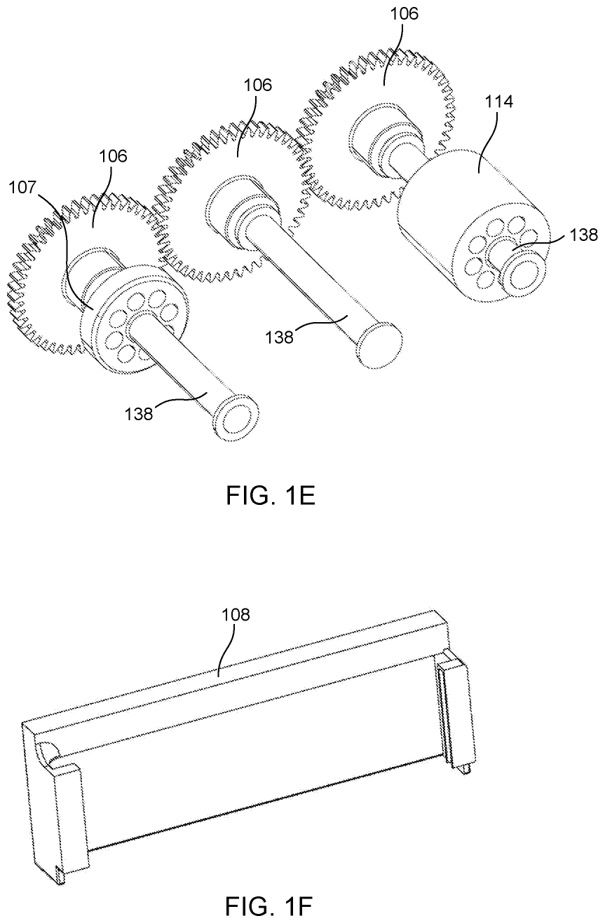

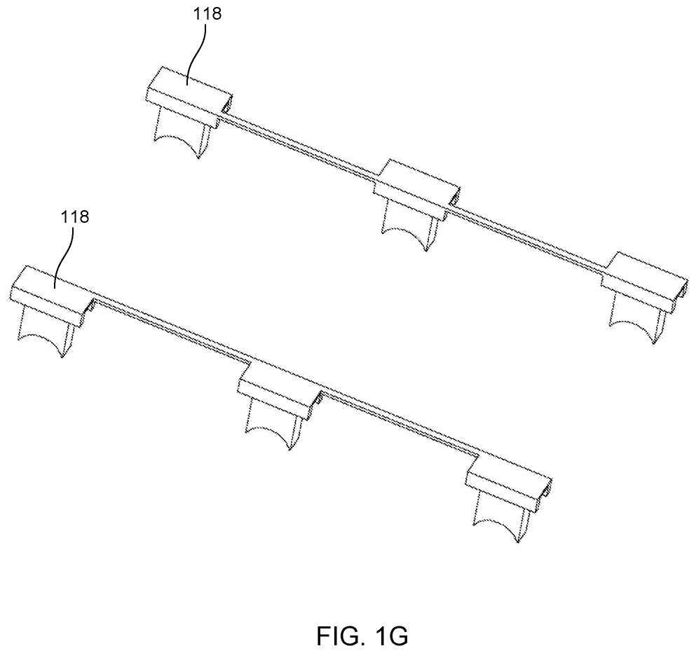

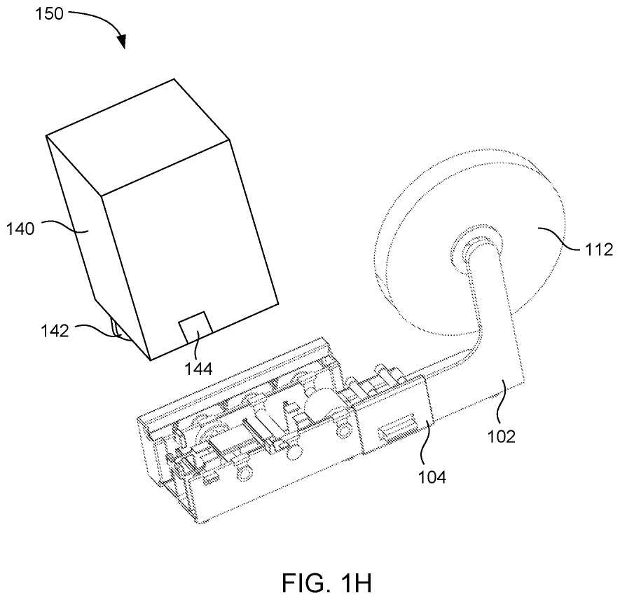

In accordance with a more specific example, FIG. 1A illustrates a schematic diagram of a media feed appliance 100 with print medium 112. The media feed appliance can include a media pull guide 102 to guide the print medium through the media feed appliance during operations of printing on the print medium. The media feed appliance can include a tensioner 104 to provide a friction enhancing media path for the print medium to travel through. The friction enhancing media path may be non-linear or serpentine such that as the print medium travels through the friction enhancing media path there is back tension or pressure generated on the print medium. This may ensure that the print medium is pulled through the media feed appliance in a uniform fashion during printing operations. The back tension also may ensure that the print medium is pulled across the surface of a roller 114 uniformly during printing operations.

The media feed appliance 100 can further include drive gears 106. In various examples, the drive gears may be one gear, three gears, or any number of gears. As the print medium 112 is pulled across the surface of the roller 114, the roller drives a first drive gear. If there is one drive gear, then the first drive gear drives a printer gear of a printer. If there is more than one drive gear then the first drive gear drives a second drive gear which drives a third drive gear which ultimately drives a printer gear of a printer. The third gear may drive a fourth gear 107 that drives the printer gear. The print medium may manually be pulled across the roller by a user and thus the drive gears may be manually driven by the user. Therefore, the drive gears and the roller may be referred to as a non-motorized drive system that is employed to drive the printer. The drive gears may be partially covered by a housing 108. The housing may protect the drive gears from coming in contact with objects such as the finger of a user. The housing may be removable and may or may not be used during printing operations. The drive gears and the roller may include an axel. The axels may fit into slots or grooves in the media pull guide 102. Once placed in the slots, the axels may then be secured into position using clips 118. The clips may secure the axels in the slots while allowing the axels to freely turn or spin in the slots.

The media pull guide 102 can further include a printer positioning port 110. The printer positioning port can be designed to position a manually actuatable printer over the media pull guide. The printer positioning port can couple with or attach the printer to the media pull guide. The printer positioning port can position the printer such that a printer gear of the printer will mechanically engage with one of the drive gears 106. The printer positioning port also aligns the printer over the print medium 112 such that a print head of the printer will print onto the print medium. FIG. 1A depicts the media pull guide with two printer positioning ports. It should be appreciated that the media pull guide may have any number of printer positioning ports. The printer positioning ports can be described as fudicial posts that ensure proper alignment of the printer within the print medium.

In one example, the media pull guide 102 can further include top slits 116 for guiding the print medium 112 through the media pull guide. The print medium may be manually loaded into the top slits. The top slits may have an opening at the top that allows for rapid loading of the print medium. The top slits may serve to align and guide the print medium as the print medium is pulled through the media pull guide. The top slits may also guide the print medium such that the print head of the printer is aligned over the print medium and the print medium is the proper spacing and/or height from the print head. For example, the print medium may be guided over a platform 109 where the print head prints on the print medium. The platform may be removable and installed on the media pull guide. It should be appreciated that any number of top slits may be formed in the media pull guide.

In one example, the components of the media feed appliance 100 may be manufactured using three dimensional printing techniques. For example, a user may be sent a digital file that contains plans or instructions for three dimensionally printing the media feed appliance. The media pull guide 102, the tensioner 104, the drive gears 106, the housing 108, the roller 114 and the clips 118 may all be three dimensionally printed. Thus an end user may three dimensionally print the media feed appliance at home or in other locations. Alternatively, the media feed appliance may be manufactured and made available to the end user for purchase.

Thus, as shown in FIG. 1A, as well as in FIGS. 1B-1H hereinafter, the present technology can include, for example, devices, systems, and methods that allow for manually pulling a print medium through a path in a media feed appliance. As mentioned, the print medium may be a media or substrate such as a ribbon that may be any length and have a width that is narrower than the length. For example, a media feed appliance can include a media pull guide to guide a print medium through a path while the print medium is manually pulled through the media feed appliance. Thus, a user can manually pull the print medium through the media feed appliance. For example, the media feed appliance further includes a tensioner to provide a friction enhancing media path to generate back tension on the print medium while moving through the media feed appliance. In one example, the friction enhancing media path created by the tensioner can be serpentine or non-linear. In one example, the print medium can be included as a rolled print medium, a ribbon print medium, a paper print medium, a tape print medium, or a plastic print medium. In other words, the print medium may be composed of any type of material including polymers, plastic, synthetic or natural fibers, rubber, paper, metallic materials, or any combinations thereof. In the context of the present disclosure, the print medium can be a media or media strip, such as in the form of rolled media, ribbon media, etc. The print medium may also be a rolled print medium, a ribbon print medium, a paper print medium, a tape print medium, or a plastic print medium. As a further note, the media feed appliance may be described as an accessory to a printer.

In accordance with a more specific example, FIG. 1B illustrates a schematic diagram of the media pull guide 102. The media pull guide depicts four sets of top slits 116 for loading the print medium 112 into the media pull guide. The top slits also guide the print medium through the media pull guide during printing operations and align the print medium under the printer head of the printer. The top slits allow a user to manually pull the print medium through the media pull guide while keeping the print medium aligned with the print head. The media pull guide further includes three sets of slots 120 for receiving axels. The axels may be for the drive gears 106 and/or the roller 114. For example, if the system includes three drive gears then an axel associated with the individual drive gears will be received by the slot while one of the axels will be associated with both the roller and one of the drive gears. Thus, when the roller is driven, the associated drive gear that shares an axel with the roller will also be driven. The top slits may also serve to ensure that the print medium is guided over the surface of the roller such that when the print medium is pulled through the media pull guide the roller is driven in a uniform manner.

The media pull guide 102 may also include tensioner posts 122. The tensioner posts can work in conjunction with the tensioner 104 to create a non-linear friction enhancing media path for the print medium 112 to travel through. The tensioner may be removed from the media pull guide while the print medium is loaded into the top slits 116. The tensioner is then placed over the tensioner posts thus forcing the print medium to travel around the tensioner posts and posts associated with the tensioner.

The media pull guide 102, which can be part of the media feed appliance shown assembled in FIG. 1A, may also include a media holder 124 for holding the print medium 112. The media holder may be supported by or attached to a neck 126 of the media pull guide. The print medium may be stored or sold in a roll with an opening in the middle of the roll that can be designed to fit over the media holder. When the print medium is manually pulled, the roll of the print medium will spin on the medial holder. The roll shape of the print medium and the media holder in conjunction therewith will allow the print medium to be dispensed during printing. The print holder may also include a fastener 128 which may be removable while the roll of the print medium is loaded onto the media holder and then reattached after loading to prevent the roll of the print medium from coming off of the media holder.

The media pull guide 102 may also include supports 130 which can be designed to provide structural support to the sidewalls of the media pull guide. The supports may assist the sidewalls in maintaining a consistent shape for the media pull guide during printing operations.

In accordance with a more specific example, FIG. 1C illustrates a schematic diagram of the tensioner 104. The tensioner or a portion of the tensioner can be removable from the media pull guide 102. The tensioner is depicted as having a handle 132 for a user to grip when removing or installing the tensioner on the media pull guide. The tensioner is depicted as including an opening 134 which may be used to clip onto a sidewall of the media pull guide. The sidewall of the media pull guide may have guides or marking to indicate where the opening is to be attached to the sidewall. The tensioner is depicted as including posts 136. The posts can work in conjunction with the tensioner posts 122 to create a non-linear friction enhancing media path for the print medium 112 to travel through. For example, the print medium may weave alternatingly between the posts of the tensioner and the tensioner posts of the media pull guide. The print medium may be loaded onto the media pull guide first and then the tensioner may be installed on the media pull guide second. Thus, the user may rapidly load the print medium onto the media pull guide and create the non-linear friction enhancing media path by installing the tensioner over the print medium. The figures depict an example with two tensioner posts 122 and three posts 136. However, any number of posts may be employed to create a non-linear friction enhancing media path for the print medium to travel through.

In accordance with a more specific example, FIG. 1D illustrates a cross-sectional view of the print medium 112 as the print medium travels through a friction enhancing media path. The print medium may be formed or stored in a roll that is held by a media holder 124 which allows the print medium to be dispensed through the friction enhancing media path during printing operations. The friction enhancing media path may then cause the print medium to travel in an alternating fashion around the tensioner posts 122 of the media pull guide 102 and the posts 136 of the tensioner 104 and then over a surface of the roller 114. The friction enhancing media path may be described as non-linear or serpentine. FIG. 1D is an example of the friction enhancing media path. It should be appreciated that any number of different friction enhancing media paths may be formed in conjunction with the present technology. The friction enhancing media path generates back tension on the print medium as the print medium travels through the friction enhancing media path. The back tension can ensure continuous contact between the print medium and the roller that turns the drive gears 106 to ensure smooth, continuous operation of the drive gears and ultimately the printer.

In accordance with a more specific example, FIG. 1E illustrates a schematic diagram of the drive gears 106. FIG. 1E depicts an example with three drive gears 106 and the fourth gear 107. It should be appreciated that any number of gears may be employed. In one example, the print medium 112 passes through a friction enhancing media path that creates tension or friction on the print medium as the print medium passes over a surface of the roller 114. The tension or friction over the surface of the roller turns the roller as the user manually pulls the print medium through the media pull guide 102. The roller then drives an axel and subsequently a first gear of the drive gears that shares an axel with the roller. The first gear then mechanically drives the next gear and so on until the fourth gear 107 is driven. The fourth gear may be designed to engage a printer gear of a printer. The components depicted in FIG. 1E may be referred to as a non-motorized drive system. In one example, the speed at which a user pulls the print medium through the media pull guide, and thus the non-motorized drive system, can control the speed at which a printer will print on the print medium. For example, if a user pulls faster, then the fourth gear 107 will be driven faster which in turn drives the printer gear faster and thus the print head will print faster. The drive gears may be designed such that the print gear will be driven at an appropriate speed for printing on the print medium. For example, the diameter of the drive gears and the fourth gear may be designed with knowledge of how fast the printer gear is to be turned to achieve the appropriate printing speed.

It should be appreciated that the media pull guide 102 may be designed to accommodate any width of print medium 112. In one example, the print medium may be 4 inches wide or narrower. The top slits 116, the tensioner posts 122, the posts 136, the media holder 124, and the media pull guide may be adjustable to allow for different widths of print medium. The adjustability may have grooves that allow for predetermined width. In one example, different components of the media pull guide may be interchangeable with different size parts to allow for different widths of print medium. For example, the roller 114 and the drive gears 106 may be replaceable with a second set of drive gears and a second roller that have different lengths of axels to accommodate a different width of print medium. Conversely the media pull guide may be designed for one width of print medium and second media pull guide may be designed for a second width of print medium.

In accordance with a more specific example, FIG. 1F illustrates a schematic diagram of the housing 108. The housing may be designed to house and cover or partially cover the drive gears 106. The housing may be employed to ensure that unwanted objects do not come in contact with the drive gears. The housing may be designed to leave the fourth gear 107 exposed such that the fourth gear may be free to contact the print gear of the printer.

In accordance with a more specific example, FIG. 1G illustrates a schematic diagram of the clips 118. The clips may secure the axels of the drive gears 106 in the slots of the media pull guide 102 while allowing the axels to freely turn or spin in the slots during printing operations. The clips may be left attached to one another in groups of three such as is depicted or may be separated and then installed on the media pull guide. Any number of clips may be made for the media pull guide depending on the number of slots the media pull guide is designed with.

In accordance with a more specific example, FIG. 1H illustrates a schematic diagram of a media print system 150. The media print system can include a printer 140. The printer can be a manually actuatable printer. A manually actuatable printer may be a printer that is actuated or driven by manually turning a printer gear 142. The print gear may be turned by the fourth gear 107 of the media pull guide 102. The printer gear may be referred to as an encoding wheel. The printer may have electronics and a power source but may not rely upon electronics and the power source to actuate or control the printing operations or the printing speed. Rather manually driving the printer via a user may control the printing process. For example, the HP, Inc. Remix™ may be employed. The media pull guide may be designed based on the specifications of the printer that is to be used with the media pull guide. Once designed for a specific printer, the media pull guide may not work with a printer of a different design. The printer may include a print head 144 for printing on the print medium 112. The print head may be an inkjet print head or another type of print head. The printer may have a replaceable ink cartridge. The ink of the printer may be specified to print on the type of print medium being employed by the user. The printer may be mobile and handheld and may not be connected to an external power source.

The printer 140 may be designed to print any type of shape, design, style or color on the print medium 112. Text and graphics may also be printed onto the print medium. Thus, a small business such as a gift shop or flower shop may print ribbon customized with logos, text, and/or graphics pertaining to the business. A user may select the design to be printed on the print medium. The printer may have controls, buttons, a display, or other interface on the printer to interact with the user. In one example, the printer has limited control on the printer and instead communicates with another device for control. For example, the printer may communicate with a computing device such as a smart phone or tablet computer. The computing device may run an operating system such as Android™ or iOS™. The computing device may have application programs installed on the computing device designed to interface with the user and send commands to the printer. Thus, a user may select a design using the computing device. The design may then be sent to the printer for printing on the print medium. The computing device and the application may have pre-made designs for the user to choose from or the user may create an original design. The user may also obtain other designs from the internet. The computing device may communicated with the printer using a wired connected or a wireless connection. For example, the printer may communicate with the computing device using Wi-Fi™ or Bluetooth™ protocols. The design may be printed using any length of print medium. The user may cut the print medium to any desired length after printing. The user may manually pull the print medium through the media pull guide 102 to actuate the printing. The printing may pause if the user stops pulling the print medium. The printing may resume if the user resumes pulling the print medium. Pausing or stopping the pulling and then resuming the pulling of the print medium may not affect the quality of the printing on the print medium. In other words, pausing or stopping and then resuming may cause no discernable break in the design printed on the print medium. The printer gear may be engaged and rolled at a speed commensurate with the speed at which the print medium is being pulled, enabling continuous printing of very long strips of print medium.

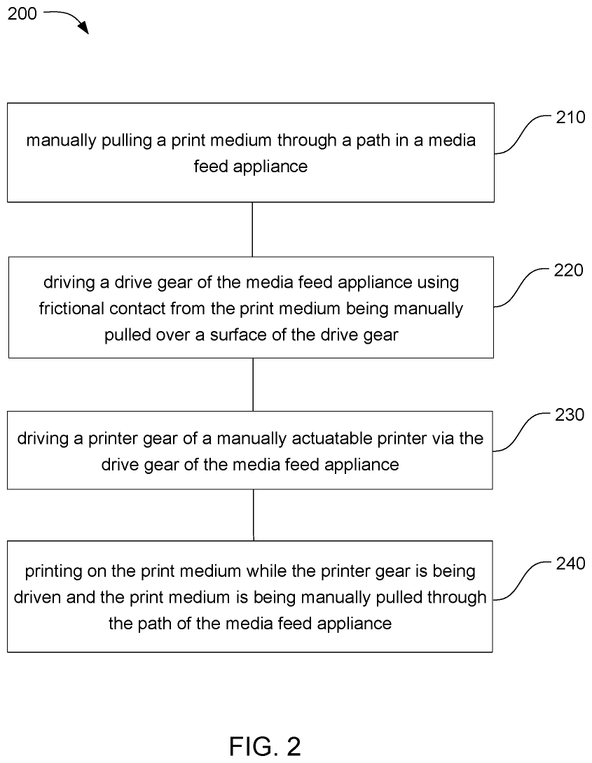

FIG. 2 is a flowchart illustrating an example method 200 of printing on a print medium. The method includes manually 210 pulling a print medium through a path in a media feed appliance. The method further includes driving 220 a drive gear of the media feed appliance using frictional contact from the print medium being manually pulled over a surface of the drive gear. The method further includes driving 230 a printer gear of a manually actuatable printer via the drive gear of the media feed appliance. In examples herein, the method further includes printing 240 on the print medium while the printer gear is being driven and the print medium is being manually pulled through the path of the media feed appliance. The method can further include loading a roll of the print medium onto a media holder of the media feed appliance to dispense the print medium during printing. The method can also include creating back tension on the print medium in the media feed appliance via a tensioner. The method can be carried out using the media feed appliances shown and described herein, such as by example in FIGS. 1A to 1H. For example, the method can be carried out using a media feed appliance that includes a media pull guide to guide a print medium through a path while the print medium is manually pulled through the media feed appliance, a drive gear that is manually driven using frictional contact with the print medium while the print medium is pulled over a surface of the drive gear, and a printer positioning port to position a manually actuatable printer to print on the print medium. The drive gear of the media feed appliance in this example can be positioned to mechanically engage with a printer gear when the manually actuatable printer is docked at the port.

While the flowcharts presented for this disclosure can imply a specific order of execution, the order of execution can differ from what is illustrated. For example, the order of two or more blocks can be rearranged relative to the order shown. Further, two or more blocks shown in succession can be executed in parallel or with partial parallelization. In some configurations, block(s) shown in the flow chart can be omitted or skipped. A number of counters, state variables, warning semaphores, or messages can be added to the logical flow for purposes of enhanced utility, accounting, performance, measurement, troubleshooting or for similar reasons.

It is noted that, as used in this specification and the appended claims, the singular forms “a,” “an,” and “the” include plural referents unless the context clearly dictates otherwise. For example, in referring to “a nozzle,” this includes a single nozzle, but could also be multiple nozzles, depending on the fluid volume to be dispensed relative to the drop volume size ejectable from individual nozzles.

As used herein, the term “about” is used to provide flexibility to a numerical range endpoint by providing that a given value may be “a little above” or “a little below” the endpoint. The degree of flexibility of this term can be dictated by the particular variable and determined based on the associated description herein.

As used herein, a plurality of items, structural elements, compositional elements, and/or materials may be presented in a common list for convenience. However, these lists should be construed as though individual members of the list are individually identified as a separate and unique member. Thus, no individual member of such list should be construed as a de facto equivalent of any other member of the same list solely based on their presentation in a common group without indications to the contrary.

Sizes, amounts, and other numerical data may be expressed or presented herein in a range format. It is to be understood that such a range format is used merely for convenience and brevity and thus should be interpreted flexibly to include the numerical values explicitly recited as the limits of the range, and also to include individual numerical values or sub-ranges encompassed within that range as if individual numerical values and sub-ranges are explicitly recited. As an illustration, a numerical range of “about 1 wt % to about 20 wt %” should be interpreted to include the explicitly recited values of about 1 wt % to about 20 wt %, and also to include individual values and sub-ranges within the indicated range. Thus, included in this numerical range are individual values such as 2, 3.5, 10, 15, and sub-ranges such as from 1-10, from 2-15, and from 10-20, etc. This same principle applies to ranges reciting a single numerical value. Furthermore, such an interpretation should apply regardless of the breadth of the range or the characteristics being described.

The above illustrates an example of the present disclosure. However, it is to be understood that the above is merely illustrative of the application of the present disclosure. Numerous modifications and alternative devices, methods, and systems may be devised without departing from the spirit and scope of the present disclosure. The appended claims are intended to cover such modifications and arrangements.

What is claimed is:

1. A media feed appliance, comprising:
a media pull guide to guide a print medium through a path while the print medium is manually pulled through the media feed appliance;
a drive gear that is manually driven using frictional contact with the print medium while the print medium is pulled over a surface of the drive gear; and
a printer positioning port to position a manually actuatable printer to print on the print medium, wherein the drive gear of the media feed appliance is positioned to mechanically engage with a printer gear when the manually actuatable printer is docked at the port.

2. The media feed appliance of claim 1, further comprising a media holder to hold and dispense the print medium during printing.

3. The media feed appliance of claim 1, wherein the media feed appliance is adjustable for different print medium widths.

4. The media feed appliance of claim 1, further comprising a tensioner to provide a friction enhancing media path to generate back tension on the print medium while moving through the media feed appliance.

5. The media feed appliance of claim 4, wherein a portion of the tensioner is detachable while the print medium is being loaded into the media feed appliance.

6. The media feed appliance of claim 4, wherein the friction enhancing media path created by the tensioner is serpentine or non-linear.

7. The media feed appliance of claim 1, wherein the drive gear is non-motorized.

8. The media feed appliance of claim 1, wherein the drive gear is included as part of a plurality of gears that are positioned so that the drive gear that contacts the print medium and a gear that engages the printer gear are operationally coupled together.

9. The media feed appliance of claim 1, wherein the print medium is included as a rolled print medium, a ribbon print medium, a paper print medium, a tape print medium, or a plastic print medium.

10. The media feed appliance of claim 1, wherein the path for the print medium has a width to accommodate a print medium that is one-fourth of an inch to four inches in width.

11. A media printing system, comprising:
a manually actuatable printer with a printer gear to drive printing on a print medium; and
a media feed appliance, comprising:
a media pull guide to guide a print medium through a path while the print medium is manually pulled through the media feed appliance,
a drive gear that is manually driven using frictional contact with the print medium while the print medium is pulled over a surface of the drive gear, and
a printer positioning port to position the manually actuatable printer to print on the print medium, wherein the drive gear of the media feed appliance is positioned to mechanically engage with a printer gear when the manually actuatable printer is docked at the port.

12. The media printing system of claim 11, wherein the manually actuatable printer is a handheld mobile printing device that employs an inkjet printing system.

13. The media printing system of claim 11, further comprising a tensioner to provide a friction enhancing media path to generate back tension on the print medium while moving through the media feed appliance.

14. A method of printing on a print medium, comprising:
manually pulling a print medium through a path in a media feed appliance;
driving a drive gear of the media feed appliance using frictional contact from the print medium being manually pulled over a surface of the drive gear;
driving a printer gear of a manually actuatable printer via the drive gear of the media feed appliance; and
printing on the print medium while the printer gear is being driven and the print medium is being manually pulled through the path of the media feed appliance.

15. The method of claim 14, further comprising loading a roll of the print medium onto a media holder of the media feed appliance to dispense the print medium during printing, and creating back tension on the print medium in the media feed appliance via a tensioner.
